(19) United States
(12) Patent Application Publication
(10) Pub. No.: US 2020/0276981 A1
(43) Pub. Date: Sep. 3, 2020

(54) System and Method to Restrict Usage of Vehicle During Ride Share

(71) Applicant: Nicholas Anderson, Knoxville, TN (US)

(72) Inventor: Nicholas Anderson, Knoxville, TN (US)

(21) Appl. No.: 16/745,403

(22) Filed: Jan. 17, 2020

Related U.S. Application Data
(60) Provisional application No. 62/812,489, filed on Mar. 1, 2019.

(51) Int. Cl. B60W 50/12; G07C 5/00; G07C 5/08; B60R 25/24

(52) U.S. Cl. CPC B60W 50/12; B60R 25/243; G07C 5/0841; G07C 5/008

(57) ABSTRACT

A method of restricting usage of a vehicle includes: storing usage information of the vehicle on a server, the usage information corresponding to usage of the vehicle based on a type of user using the vehicle; determining with a processor whether a user of the vehicle is an owner user or non-owner user of the vehicle; retrieving usage parameters of the vehicle based on whether the user is determined to be the owner user or the non-owner user; and transmitting usage instructions to a control module of the vehicle based on whether the user is the owner user or the non-owner user.

### CROSS-REFERENCE TO RELATED APPLICATION

This application claims priority to and is a non-provisional of U.S. Patent Application Ser. No. 62/812,489 for a “System and Method to Restrict Usage of Private Vehicle During Ride Share” filed on Mar. 1, 2019, the contents of which are incorporated herein by reference in its entirety.

### FIELD

This disclosure relates to the field of vehicles. More particularly, this disclosure relates to systems and methods of securing and restricting use of a vehicle during use of the vehicle by third parties.

### BACKGROUND

Car-sharing, ride-sharing and ride hailing provide an effective means of transportation wherein an owner of a vehicle provides a ride to a passenger in the owner's vehicle. In many usage cases, the owner of a vehicle allows another person to use and/or drive their vehicle without the owner being present in the vehicle. Owners of vehicles increasingly utilize vehicles for transportation of others in return for a fee.

While car-sharing, ride-sharing and ride hailing are beneficial for owners of vehicles, difficulties exist in making a vehicle available for use by one or more third parties unaffiliated with the owner of the vehicle. For example, certain belongings of the owner of the vehicle may be contained within the vehicle, such as within compartments of the vehicle, and it may be difficult to continuously add and remove personal belongings from the vehicle when the vehicle is made available for use by third parties. Further, the owner of the vehicle may desire to leave personal items of the owner in the vehicle without concern for those items being stolen or inadvertently removed from the vehicle by someone other than the owner.

Owners of vehicles may also desire to limit use of the vehicles within certain desired parameters such as maximum speed, distance, and geographic area in which the vehicle is allowed to travel.

As vehicles achieve higher and higher levels of autonomous capabilities and gain the ability to drive themselves, these and other similar issues become increasingly significant. What is needed, therefore, is a system and method to restrict usage of a vehicle when in use by a third party.

### SUMMARY

What is needed therefore, is a system and method of restricting usage of a vehicle during a ride-share use of the vehicle or other use by non-owner third parties. In a first aspect, a method of restricting usage of a vehicle includes: storing usage information of the vehicle on a server, the usage information corresponding to usage of the vehicle based on a type of user using the vehicle; determining with a processor whether a user of the vehicle is an owner user or non-owner user of the vehicle; retrieving usage parameters of the vehicle based on whether the user is determined to be the owner user or the non-owner user; and transmitting usage instructions to a control module of the vehicle based on whether the user is the owner user or the non-owner user.

In one embodiment, the method further includes receiving a request for use of the vehicle by the user on a third party ride-sharing system, wherein usage instructions to the control module of the vehicle are transmitted from the third-party ride-sharing system. In another embodiment, the method further includes receiving instructions from a device of the owner of the vehicle to activate a non-owner mode of the vehicle and transmitting instructions to the control module of the vehicle that the user is the non-owner user of the vehicle. In yet another embodiment, the method further includes receiving instructions from a device of a non-owner user of the vehicle to activate a non-owner mode of the vehicle and transmitting instructions to the control module of the vehicle that the user is the non-owner user of the vehicle.

In one embodiment, the usage instructions prevent operation of the vehicle above a designated speed when the user is the non-owner user. In another embodiment, the usage instructions prevent or allow user pick-up or drop off locations or travel routes by the vehicle.

In yet another embodiment, the method further includes determining whether a user requesting use of the vehicle on the third-party ride-sharing system is qualified to use the vehicle and transmitting usage instructions to the control module of the vehicle if the user is determined to be qualified for use of the vehicle.

In one embodiment, the usage instructions prevent operation of the vehicle in a particular area based on an ability of the vehicle to be returned to a desired location at a designated time.

In a second aspect, a method of restricting access to compartments of a vehicle includes: storing compartment access information of the vehicle on a server, the compartment access information corresponding to access to the compartments of the vehicle based on a type of user requesting use of the vehicle; receiving with a processor a request for use of the vehicle by a user; determining with a processor whether the user requesting use of the vehicle is an owner of the vehicle; retrieving access parameters of the vehicle from the stored compartment access information of the vehicle based on whether the user is determined to be an owner user or a non-owner user; and transmitting access instructions to a control module of the vehicle corresponding to the user requesting use of the vehicle, wherein the access instructions prevent or allow access to one or more of the compartments of the vehicle if the user is determined to be a non-owner user.

In one embodiment, the compartments of the vehicle are selected from the group consisting of a glove box, compartment, trunk, center console, sunglasses holder, engine compartment/hood, and spare tire compartment of the vehicle. In another embodiment, the vehicle further includes one or more actuators installed on the compartments of the vehicle for opening and closing the compartments of the vehicle.

In yet another embodiment, the method further includes receiving a request for access to one of the compartments of the vehicle from a non-owner user, transmitting the request for access to one of the compartments of the vehicle to an owner user, and upon receiving approval to access one of the compartments of the vehicle from the owner user, transmitting instructions to the vehicle to enable access to the requested compartment of the vehicle.

In one embodiment, the vehicle further includes one or more actuators installed on a lock of compartments of the vehicle for one of locking and unlocking the compartments of the vehicle. In another embodiment, the method further includes providing a user device to an owner of the vehicle and receiving access parameters from the owner of the vehicle through an interface on the user device.

In yet another embodiment, the method further includes providing a user interface on a display of the vehicle, and wherein access parameters are provided through the display on the vehicle.

In one embodiment, the method further includes transmitting instructions to the control module of the vehicle to activate one or more cameras located on the vehicle when the vehicle is in use by a non-owner user. In another embodiment, the vehicle is an autonomous vehicle.

In yet another embodiment, the compartments of the vehicle are selected from the group consisting of a glove box, trunk, and center console of the vehicle. In one embodiment, the vehicle includes one or more actuators installed on the compartments of the vehicle for opening the compartments of the vehicle.

In a third aspect, a method of restricting access to compartments of a vehicle includes: receiving access parameters from an owner user of the vehicle through an interface on a user device of the owner user; storing received access parameters of the vehicle on a server, the access parameters corresponding to access to the compartments of the vehicle based on a type of user requesting use of the vehicle; receiving with a processor a request for use of the vehicle by a user; determining with a processor whether the user requesting use of the vehicle is an owner of the vehicle; retrieving access parameters of the vehicle from the store access information of the vehicle based on whether the user is determined to be an owner user or a non-owner user; and transmitting access instructions to a control module of the vehicle corresponding to the user requesting use of the vehicle, wherein the access instructions prevent access to one or more of the compartments of the vehicle if the user is determined to be a non-owner user.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1A shows a system for use of a vehicle by third parties according to one embodiment of the present disclosure;

FIG. 1B shows a system for use of a vehicle by third parties through a ride-sharing system according to one embodiment of the present disclosure;

FIG. 2 shows a diagram of a vehicle according to one embodiment of the present disclosure;

FIG. 3 shows a flowchart of a system and method of use of a vehicle by third parties according to one embodiment of the present disclosure;

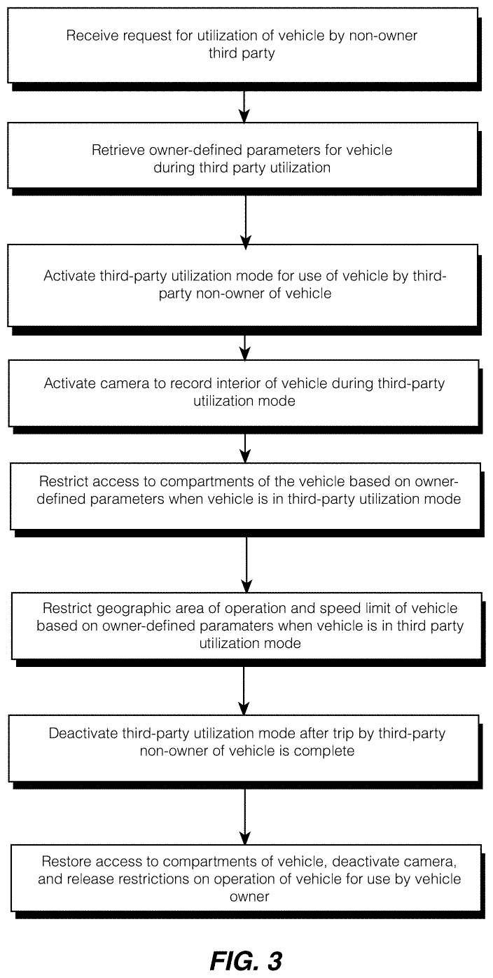

FIG. 4 shows a user interface including a toggle for activating a third party utilization mode according to one embodiment of the present disclosure;

FIG. 5 shows a user interface including one or more selectable user profiles according to one embodiment of the present disclosure; and

FIG. 6 shows a user interface including one or more selectable parameters for a user of a vehicle according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Embodiments of the present disclosure include a system and method of restricting usage of a vehicle while in use by a third party. Multiple embodiments of third-party vehicle utilization, including car-sharing, ride-sharing, and ride-hailing, car-rental, and taxi services and also including vehicles under autonomous control, human control, or a combination of both autonomous and human control are included in this embodiment. Throughout the disclosure, the terms “third-party vehicle utilization” and “third-party utilization” may include car-sharing, ride-sharing, and ride-hailing, car-rental, and taxi services, and also including vehicles under autonomous control, human control, or a combinations of the two. Embodiments of the present disclosure may refer to use of a vehicle by individuals other than an owner of the vehicle and use of the terms “car-sharing”, “ride-sharing”, “ride-hailing”, “car-rental”, and “taxi services”, or “third-party utilization” are not intended to be limiting. It is understood that various embodiments of the present disclosure may be suitable for autonomous and non-autonomous vehicles.

As referred to herein, an “owner” of a vehicle may refer to an individual who personally owns one or more vehicles. For example, an owner may be an individual owning one or more vehicles that are privately used by the owner. Alternatively, an owner may refer to an individual associated with an entity that owns a plurality of vehicles to be used for third-party vehicle utilization. For example, an owner may refer to the entity owning the vehicles or an individual managing vehicles of the entity, such as an authorized vehicle manager of the vehicle owning entity.

In the present disclosure usage of the vehicle by a third-party is restricted in a third party utilization mode according to parameters desired by the owner of the vehicle. Third-party utilization mode may refer to activating a mode of the vehicle in which restrictions may be placed on the vehicle based on use of the vehicle by an individual other than the owner or individual associated with the owner. In third-party utilization mode, various restrictions may be placed on access to compartments of the vehicle, access to a maximum speed of the vehicle, pick-up/drop-off/travel restrictions of the vehicle, and recording of video in areas proximate to the vehicle. An owner of a vehicle may restrict use of the vehicle such as by activating a third-party utilization mode to lock designated compartments of the vehicle. An owner of a vehicle may further limit use of the vehicle within certain desired parameters such as maximum speed, distance, and geographic area in which the vehicle is allowed to travel. An owner of a vehicle may also monitor the interior and exterior of the vehicle via camera while it is being used by a third party.

In one embodiment, the owner of the vehicle restricts use of the vehicle for third-party utilization through a user device, and preferably using a mobile application installed on the user device. The user device communicates with a vehicle control module of the vehicle to restrict usage of the vehicle according to commands received from the owner of the vehicle. In another embodiment the owner of the vehicle restricts use of the vehicle for third-party utilization through an interface and control module embedded in the vehicle. In other embodiments, pre-set vehicle restrictions are automatically engaged when any user other than the vehicle's owner, or other designated vehicle manager, enter or otherwise utilize the vehicle in the absence of the owner or authorized vehicle manager.

The vehicle may be utilized by a person other than the owner through a third-party entity, such as through an entity that facilitates the sharing of vehicles with customers of the entity through a mobile application or software. A transportation network company is an illustrative example of a third-party entity that facilitates the sharing of vehicles with customers of the entity through a mobile application or software. In one embodiment, a third-party utilization mode is automatically activated when a non-owner user accesses the vehicle via a transportation network company.

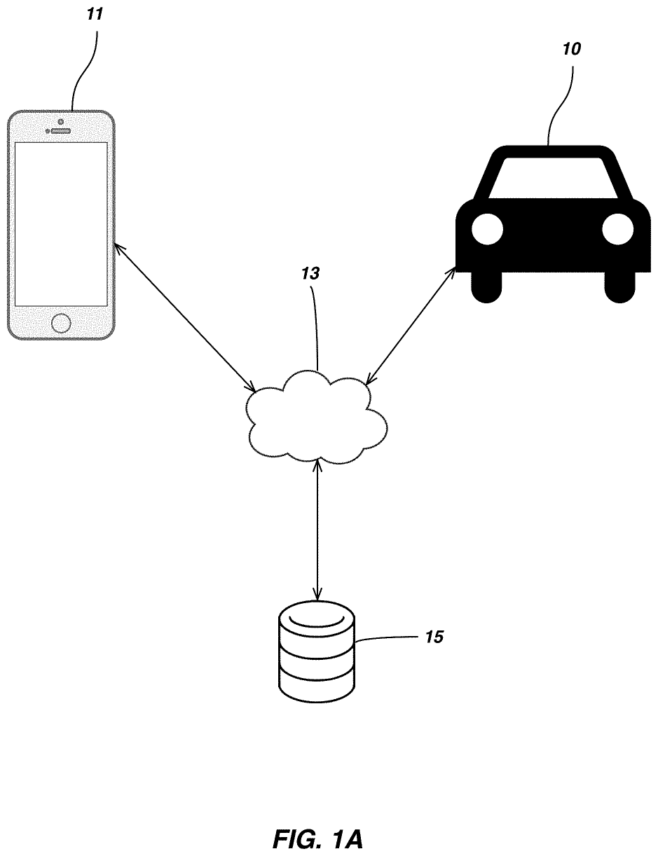

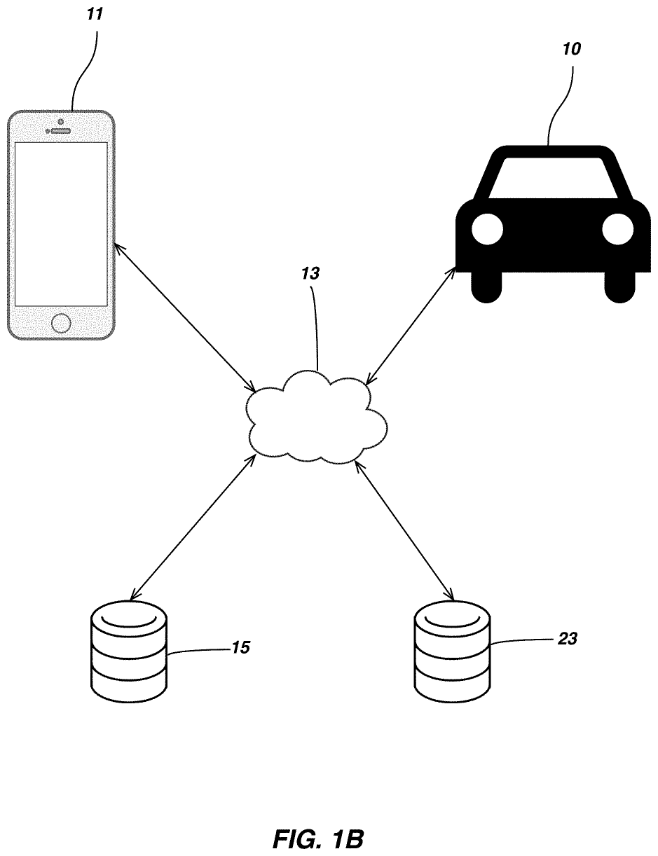

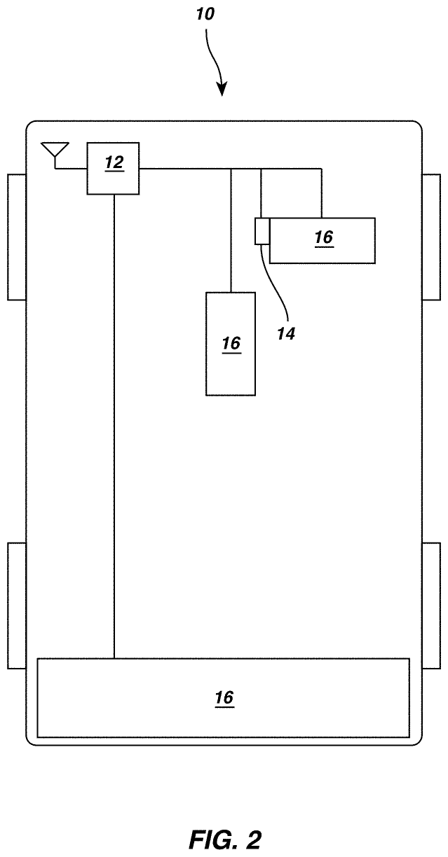

As shown in FIG. 1A, embodiments of the present disclosure include systems and methods implemented when a vehicle 10 is utilized by a third party. Instructions may be inputted into an interface operable on a user device 11, such as a smart phone or other computing device. The instructions may be transmitted over a network 13 to a vehicle and an onboard computer of the vehicle to activate or deactivate certain features of a vehicle 10 (shown in FIG. 2) as described in greater detail below. Embodiments of the present disclosure may be operable on an existing onboard controller of the vehicle 10 or by installing additional hardware controllers on the vehicle 10 to activate or deactivate features of the vehicle 10 as described herein. Onboard hardware of the vehicle 10 preferably includes a control module 12 (FIG. 2), a communications component, GPS antenna, and one or more motors/servos/locking mechanisms 14 in communication with the control module for controlling various components of the vehicle. The user device 11 and vehicle 10 may further be in communication with a server 15 (FIG. 1A) via the network 13, such as over the Internet.

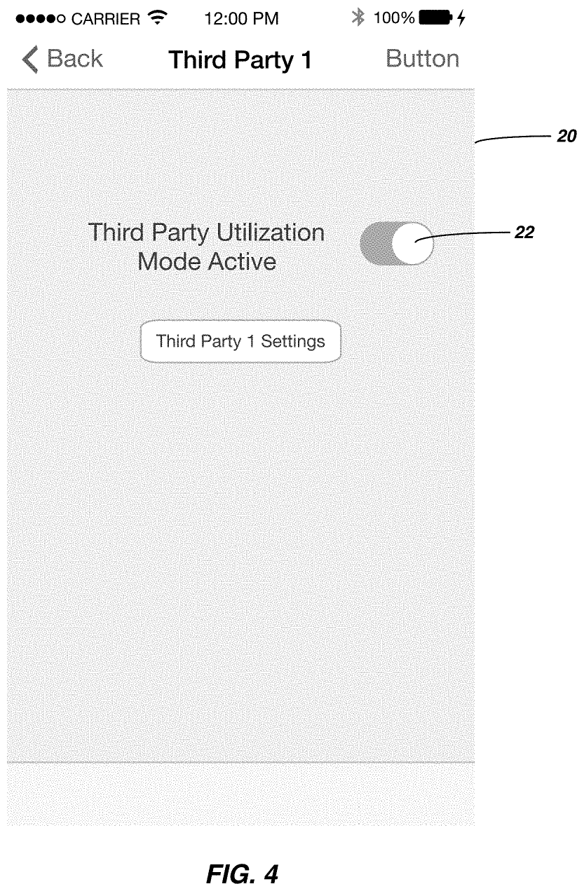

In one embodiment, a system and method of securing one or more compartments 16 of a privately-owned vehicle when the vehicle is in use by a third party in a third-party utilization mode is described. Using an interface 20 displayed on a display of the user device 11 (FIG. 4) or other computing device of a user, the vehicle owner or authorized manager of the vehicle 10 may input that the vehicle 10 is in use in a third-party utilization mode. The user may engage a third party utilization mode toggle 22 on the interface to activate third party utilization mode for the vehicle. In a third-party utilization mode, certain compartments of the vehicle may be designated as locked to prevent access to compartments of the vehicle by a third-party user. Other usage restrictions may be implemented while the vehicle is in third-party mode, such as maximum speed, restrictions on pick-up and drop-off locations, distance and geographic area in which the vehicle is allowed to travel. Video recording of the passenger compartment, storage compartment/trunk, and outward-looking camera views may also be implemented while the vehicle is in third-party mode. While a third-party utilization mode may be designated and activated by the vehicle owner or authorized manager through the interface on the mobile device or other computing device of the vehicle owner or authorized manager, third-party utilization mode may also be activated on the vehicle in other various methods such as an interface and control module integrated into the vehicle.

For example, in one embodiment when the vehicle is requested for third-party utilization, such as through a third-party transport network company, taxi service, or car rental service, the vehicle may enter the third-party utilization mode when the user requesting the vehicle is near the vehicle or enters the vehicle. A location of the user requesting the vehicle may be determined based on a location of a mobile device of the requesting user, such as using GPS or Bluetooth to determine proximity of the requesting user to the vehicle.

In another embodiment, the vehicle may enter the third-party utilization mode when a third-party user unlocks, enters, starts, activates, rents, hails, or otherwise uses the vehicle using their mobile device or other computing device. Alternatively, the vehicle may enter the third-party utilization mode when a third-party user unlocks, enters, starts, activates, hails, or otherwise uses the vehicle using a specified key, key fob, code input on a keypad or other input device, or using biometric identification. In a further embodiment, the vehicle may enter the third-party utilization mode whenever the vehicle owner leaves or locks the vehicle.

Referring to FIG. 1B, embodiments disclosed herein may be integrated or in communication with one or more ride-sharing servers 23. The one or more ride-sharing servers 23 are preferably part of a ride-sharing system such that access to or use of a vehicle may be granted through the ride-sharing system. Ride-sharing systems may include, for example, services that allow rental or use of a vehicle through a platform, such as by allowing a user to request use of a vehicle through the user device 11. One example of such a ride-sharing system is a transportation network company.

Embodiment herein include storing user data on the one or more ride-sharing servers 23. Further, request for access to a vehicle may be transmitted to the one or more ride-sharing servers 23 from the user device 11, and in response instructions may be transmitted to the vehicle 10 as described herein such that the vehicle 10 becomes available for use by a user that is not an owner of the vehicle 10. For example, a user of the ride-sharing system may request use of a vehicle 10 that is either owned by the ride-sharing system provider or by a third party allowing access to the vehicle 10 through the ride-sharing system. When the user requests access to the vehicle 10, the request is transmitted to one or both of the ride-sharing servers 23 and the server 15. An identity of the user may be verified, such as by determining whether the user is allowed to use the vehicle 10 based on data of the user (such as age, driving history, subscription level, and other data of the user). If the user is determined to be a user capable of or qualified to use the vehicle 10, usage instructions are subsequently transmitted to the vehicle 10 such that the vehicle may be used in a third-party mode by the user.

Upon entering a third-party utilization mode, the control module of the vehicle activates one or more locks on compartments of the vehicle to prevent the requesting user from accessing those compartments of the vehicle thereby allowing an owner/authorized manager of the vehicle to secure items within the compartments. One or more of the compartments of the vehicle may include a glove box, center console, trunk (and secondary trunk access such as through a rear seat of the vehicle), sunglasses holder, spare tire compartment, engine compartment/hood, and other compartments of the vehicle. The vehicle preferably includes an electronically actuated lock such as a motor servo, magnet, or other mechanical device for securing the compartments in a closed arrangement to prevent unauthorized access to the compartments. In one embodiment, the compartments further include one or more temporary or other storage compartments installed after manufacture of the vehicle, such as a compartment located in a trunk of the vehicle.

In one embodiment, the vehicle further includes one or more motors or other mechanical devices for opening or closing the compartments of the vehicle. For example, one or more motors in electronic communication with the control module of the vehicle enable the compartments to be either closed or opened by an authorized user through an interface on a device of the user. The one or more motors are connected to the one or more compartments for opening or closing compartments of the vehicle in response to the vehicle being in a third-party utilization mode. Therefore, if the compartment was left open and the locking mechanism cannot be engaged, a motor servo, magnet, or other mechanical device can be used to close the compartment, allowing the locking mechanism to be engaged. In a further embodiment, the passenger may request, either through a computing device and preferably an application on a mobile device or through a control module in the vehicle, that a specific compartment be opened or unlocked by the vehicle owner or manager. The request is transmitted to and displayed on a user device of the owner such that the owner may approve or disapprove the request for access to the specific compartment requested. The vehicle owner or manager may then, again preferably through a computing device and preferably an application on a mobile device, open or unlock the specified compartment.

In one embodiment, access to certain compartments of the vehicle may be restricted during third-party utilization of the vehicle but may be automatically allowed if certain vehicle conditions are found to exist. For example, access to a trunk or other compartment of the vehicle may be restricted during third-party utilization which may prevent access to tools or a spare tire of the vehicle located in the compartment. Access to those compartments may automatically be granted if an event of the vehicle is detected. For example, if a tire pressure sensor of the vehicle indicates that a tire is flat, access to the compartment may automatically be granted to the third-party operator of the vehicle. After the flat tire is fixed, the compartment may subsequently be locked to prevent further access to the compartment. Access to other compartments may similarly be automatically granted to the third-party operator in response to other events detected on the vehicle.

Methods of a third-party utilization mode of a vehicle include locking the compartments of the vehicle when the vehicle is in a third-party utilization mode. For example, a vehicle owner use may designate the vehicle as in use for third-party utilization using an interface on a mobile device of the user. The user may further define which of the compartments of the vehicles are to be locked during third-party use of the vehicle. The user may designate some of the compartments of the vehicle as being unlocked during third-party use of the vehicle. In one embodiment, the third-party user of the vehicle may be able to view which vehicle compartments are available using their mobile device or other computing device before hiring the vehicle.

In one embodiment, when a vehicle owner/authorized manager exits and locks the vehicle during normal use by the owner/authorized manager of the vehicle the compartments are also locked. If the vehicle is then designated as in use third-party utilization, a third-party user may be allowed to unlock the doors of the vehicle while being restricted from unlocking compartments locked by the vehicle owner/authorized manager user when the doors of the vehicle were locked.

Additional embodiments of systems and methods described herein include video recording of an interior of the vehicle as well as outward views captured by cameras mounted on the vehicle during third-party use. One or more cameras or other recording devices are located in an interior and/or exterior of the vehicle for capturing a field of view that includes the interior of the vehicle, including passenger compartment, storage compartments/trunk, as well as outward-looking camera views. The one or more cameras are preferably in electronic communication with the control module such that the one or more cameras may be activated or deactivated and further transmit data captured on the cameras. The one or more cameras may be activated upon entry of a third-party user into the vehicle and/or at implementation of a third-party utilization mode and are preferably activated only during third-party use of the vehicle. The one or more cameras may therefore be automatically de-activated when third-party mode is disengaged and/or when third-party usage of the vehicle stops. Recordings captured by the one or more cameras may be stored in association with data related to the third-party user or third-party trip, such as with a ride ID corresponding to a particular third-party user or third-party trip. A display on an interior of the vehicle may display to passengers/drivers that the cameras are recording, such as by displaying a visual indicator on a dash-mounted display of the vehicle.

Additional embodiments of systems and methods described herein include selection criteria of third-party users of the vehicle. In one embodiment, the vehicle owner/authorized manager may require that potential third-party users of the vehicle fall within a specified age range. In another embodiment, the vehicle owner/authorized manager may require that potential third-party users of the vehicle fall within a specified user rating on a transport network company's user rating system or other rating system. In yet another embodiment, the vehicle owner/authorized manager may limit potential third-party users based on their driving history (based on, for example, a motor vehicle report). Preferentially, the vehicle owner/authorize manager may set these restrictions using the computer software/app of the third-party entity/transport network company or other entity connecting passengers to vehicle owners/managers.

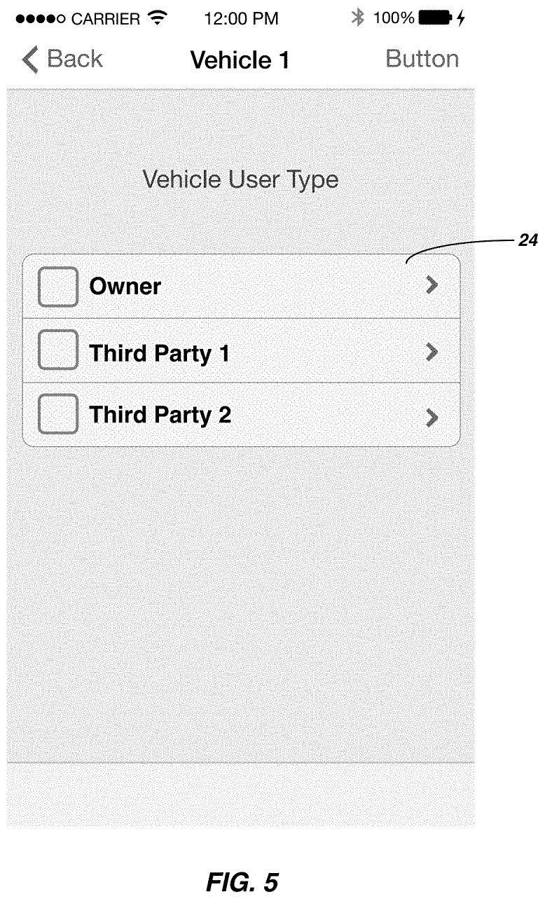

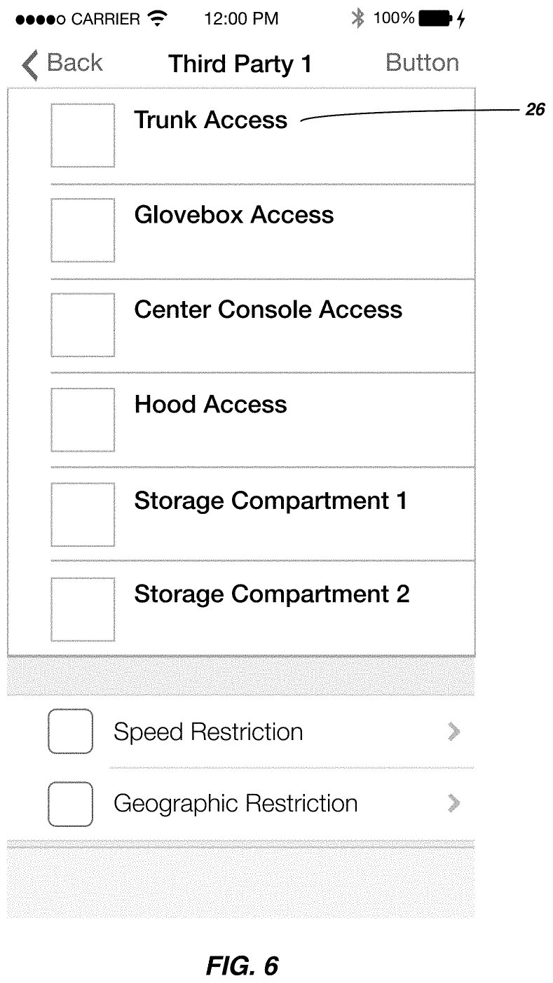

The owner of the vehicle may further create one or more selectable profiles 24 corresponding to parameters for various types of third-party operators of the vehicle, as shown in FIG. 5. For example, the owner may create at least first and second third-party utilization profiles corresponding to types of third-party operators of the vehicle. The owner of the vehicle may input various parameters described herein for a particular third-party operator of the vehicle and may subsequently select a particular profile for designating the vehicle for third-party utilization. As shown in FIG. 6, each profile may be customizable by the user to designate parameters for use of the vehicle. For example, the user may select one or more access rights 26 to the vehicle on a page that allows the owner of the vehicle to customize access to the vehicle by a third party during third-party utilization of the vehicle.

Alternatively, one of multiple profiles may automatically be selected for third-party utilization depending on characteristics of the third-party operator requesting use of the vehicle. For example, a profile may be created for particular ages of operators, wherein access to certain compartments or restrictions on operation of the vehicle may be implemented if the user requesting access to the vehicle fits within a particular group of operators.

Additional embodiments of systems and methods described herein include mobile-device based systems and methods to allow third-party users to lock/unlock and start/activate a vehicle. Preferentially, the computer software/app of the third-party entity/transport network company connecting passengers to vehicle owners/managers would allow the third-party user to lock/unlock and start/activate the vehicle. Alternatively, the computer software/app of the third-party entity/transport network company connecting passengers to vehicle owners/managers would unlock a lockbox on the exterior of the vehicle containing a key or key fob which a third-party user could use to lock/unlock and start/activate a vehicle in third-party utilization mode.

Embodiments of systems and methods disclosed herein further include limiting access or parameters of the vehicle. Access limitation or parameters of the vehicle may be inputted using a user device of the vehicle owner to transmit limitations or parameters to a database and subsequently limit access to the vehicle or designate parameters desired by the vehicle owner. In one embodiment, restrictions may be placed on the vehicle when the vehicle is in use for third-party utilization by restricting a geographic area in which the vehicle may travel. Third-party user destinations or pick-up locations may be restricted to inside or outside a particular geographic boundary (such as a ZIP code, city border, county border, state border, country border, etc.). Travel routes which are inside or outside a particular geographic boundary may also be restricted. Further, certain specific destinations or pick-up locations or categories of pick-up or drop-off locations (bars or nightclubs, for example) may be restricted to prevent the vehicle from travelling to those specific locations. Embodiments further include restricting destinations or pick-up areas and/or travel routes based on data associated with a geographic area. For example, geographic areas having a crime rate above a designated threshold may be designated as restricted to prevent the vehicle from travelling to or through that particular area. A vehicle owner/authorized manager may designate areas displayed on a map or a list of geographic areas on a computing device of the vehicle owner as being restricted to further control geographic areas in which the vehicle is authorized to travel. In a further embodiment the owner may modify geographic restrictions based upon time of day and/or day of the week and/or specific dates. Geographic restrictions may be placed on the vehicle such as by geofencing or by inputting geographic information such as zip code, city name, state, and by further providing a distance from a particular geographic area. In one embodiment a digital interface may be provided to the owner on a user device or vehicle-integrated display interface which shows the current vehicle location on a map as well as surrounding areas to facilitate owner input of allowed/restricted areas for vehicle access. In a further embodiment geographic boundaries such as city border, county border, state border, country border, or ZIP codes may also be displayed on the map on the user display as owner-selectable regions in which the vehicle is allowed or not allowed for third-party pick-up or drop-off or travel. In yet another embodiment a digital interface may be provided to the owner on a user device displaying a list of geographic areas in proximity to the vehicle location, such as ZIP codes, city borders, county borders, state borders, and country borders as owner-selectable regions in which the vehicle is allowed or not allowed for third-party pick-up or drop-off or travel.

Additional restrictions may be imposed based on distance, time of travel of the vehicle (such as whether the vehicle can return to the vehicle owner by a designated time), or based on fuel level or battery charge of the vehicle and required fuel or battery charge required to complete a third-party trip and return the vehicle to a destination specified by the vehicle owner/authorized manager.

A vehicle owner/authorized manager user may further restrict other parameters of the vehicle such as by imposing a maximum speed at which the vehicle is allowed to travel in a third-party utilization mode through a user device of the user as described above. Other restrictions may include limiting the vehicle to prevent travel over a posted speed limit of a particular road being travelled by the vehicle or a designated threshold maximum or percentage amount by which the vehicle may exceed a posted speed limit.

Embodiments of the present disclosure are advantageously implemented on vehicles that are allowed for use by third-parties. Vehicles may include human-controlled vehicles and autonomous vehicles. Embodiments of the present disclosure advantageously allows for the use of the vehicle by a non-owner entity while allowing the owner to place restrictions on the usage of the vehicle. Further, parameters of the vehicle may restrict access to the vehicle or use of the vehicle remotely from a user's smartphone or other portable device or may be restricted automatically when a non-owner user requests use of the vehicle.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method of restricting usage of a vehicle, the method comprising:
storing usage information of the vehicle on a server, the usage information corresponding to usage of the vehicle based on a type of user using the vehicle;
determining with a processor whether a user of the vehicle is an owner user or non-owner user of the vehicle;
retrieving usage parameters of the vehicle based on whether the user is determined to be the owner user or the non-owner user; and
transmitting usage instructions to a control module of the vehicle based on whether the user is the owner user or the non-owner user.

2. The method of claim 1, further comprising receiving a request for use of the vehicle by the user on a third party ride-sharing system, wherein usage instructions to the control module of the vehicle are generated based on the third-party ride-sharing system.

3. The method of claim 1, further comprising receiving instructions from a device of the owner of the vehicle to activate a non-owner mode of the vehicle and transmitting instructions to the control module of the vehicle that the user is the non-owner user of the vehicle.

4. The method of claim 1, further comprising receiving instructions from a device of a non-owner user of the vehicle to activate a non-owner mode of the vehicle and transmitting instructions to the control module of the vehicle that the user is the non-owner user of the vehicle.

5. The method of claim 1, wherein the usage instructions prevent operation of the vehicle above a designated speed when the user is the non-owner user.

6. The method of claim 1, wherein the usage instructions prevent or allow user pick-up or drop off locations or travel routes by the vehicle.

7. The method of claim 1, wherein the usage instructions prevent operation of the vehicle in a particular area based on an ability of the vehicle to be returned to a desired location at a designated time.

8. The method of claim 2, further comprising:
determining whether a user requesting use of the vehicle on the third-party ride-sharing system is qualified to use the vehicle and
transmitting usage instructions to the control module of the vehicle if the user is determined to be qualified for use of the vehicle.

9. The method of claim 1, further comprising providing a user device to an owner of the vehicle and receiving access parameters from the owner of the vehicle through an interface on the user device.

10. The method of claim 1, wherein the vehicle is an autonomous vehicle.

11. The method of claim 1, further comprising transmitting instructions to the control module of the vehicle to activate one or more cameras located on the vehicle when the vehicle is in use by a non-owner user.

12. A method of restricting access to compartments of a vehicle, the method comprising:
storing compartment access information of the vehicle on a server, the compartment access information corresponding to access to the compartments of the vehicle based on a type of user requesting use of the vehicle;
receiving with a processor a request for use of the vehicle by a user;
determining with a processor whether the user requesting use of the vehicle is an owner of the vehicle;
retrieving access parameters of the vehicle from the stored compartment access information of the vehicle based on whether the user is determined to be an owner user or a non-owner user; and
transmitting access instructions to a control module of the vehicle corresponding to the user requesting use of the vehicle, wherein the access instructions prevent or allow access to one or more of the compartments of the vehicle if the user is determined to be a non-owner user.

13. The method of claim 11 wherein the compartments of the vehicle are selected from the group consisting of a glove box, compartment, trunk, center console, sunglasses holder, engine compartment/hood, and spare tire compartment of the vehicle.

14. The method of claim 11 the vehicle further including one or more actuators installed on the compartments of the vehicle for at least one of opening and closing the compartments of the vehicle.

15. The method of claim 11 further comprising receiving a request for access to one of the compartments of the vehicle from a non-owner user, transmitting the request for access to one of the compartments of the vehicle to an owner user, and upon receiving approval to access one of the compartments of the vehicle from the owner user, transmitting instructions to the vehicle to enable access to the requested compartment of the vehicle.

16. The method of claim 11, the vehicle further including one or more actuators installed on a lock of compartments of the vehicle for one of locking and unlocking the compartments of the vehicle.

17. The method of claim 11, further comprising providing a user interface on a display of the vehicle, and wherein access parameters are provided through the display on the vehicle.

18. The method of claim 15, wherein the compartments of the vehicle are selected from the group consisting of a glove box, compartment, trunk, center console, sunglasses holder, engine compartment/hood, and spare tire compartment of the vehicle of the vehicle.

19. The method of claim 11, the vehicle further including one or more actuators installed on the compartments of the vehicle for opening the compartments of the vehicle.

20. A method of restricting access to compartments of a vehicle, the method comprising:
receiving access parameters from an owner user of the vehicle through an interface on a user device of the owner user;
storing received access parameters of the vehicle on a server, the access parameters corresponding to access to the compartments of the vehicle based on a type of user requesting use of the vehicle;
receiving with a processor a request for use of the vehicle by a user;
determining with a processor whether the user requesting use of the vehicle is an owner of the vehicle;
retrieving access parameters of the vehicle from the store access information of the vehicle based on whether the user is determined to be an owner user or a non-owner user; and
transmitting access instructions to a control module of the vehicle corresponding to the user requesting use of the vehicle, wherein the access instructions prevent access to one or more of the compartments of the vehicle if the user is determined to be a non-owner user.
